(19) United States
(12) Patent Application Publication
(10) Pub. No.: US 2002/0133403 A1
(43) Pub. Date: Sep. 19, 2002

(54) System for transmitting promotional information

(76) Inventors: Michael R. Bissell, Portland, OR (US); Julian H. Scaff, Monrovia, CA (US); Robert L. McClinton, Burbank, CA (US)

Correspondence Address: Sheldon & Mak, 225 South Lake Avenue, 9th Floor, Pasadena, CA, 91101, US

(21) Appl. No.: 09/809,660

(22) Filed: Mar. 15, 2001

(51) Int. Cl. G06F 17/60

(52) U.S. Cl. 705/14

(57) ABSTRACT

A method for transmitting marketing information to a user of a computer network, where the user has an e-mail address. An advertisement is presented on a website on the computer network. The advertisement has an option which allows the user to request, without leaving the website, to view subsequent promotional information sent to the user's email address. After a request is received from the user for delivery of the promotional information, the information is sent to the user's email address.

### BACKGROUND

The present invention relates generally to a method for transmitting promotional information to a user of a computer network, and more particularly to methods for sending advertisements which allow the user to view promotional information relating to the advertisements at a later time without interrupting what the user is doing on the site the user is visiting.

Currently, online advertising requires a user on a website, who is interested in an advertisement presented on the website, to click on the advertisement and leave the site on which the visitor viewed the advertisement. The user is directed to a different website which contains promotional information relating to the advertisement. A problem arises when the user is interested in obtaining more information regarding the advertisement, but the user does not want to leave the website the user is currently viewing, or the user does not want to be interrupted from what the user is doing. The user must choose between remaining on the current website or leaving the website to gain information relating to the advertisement. Current advertising technology does not provide a method or system which allows a user interested in an ad to remain on the current website and still obtain information regarding the ad at a later, more convenient time. This is problematic and one of the disadvantages to current advertising systems, since many viewers do not want to interrupt their time on the first website by going to a different website. As a result, many users forego obtaining information relating to advertisements presented on websites and the information does not reach the user. It is disadvantageous to both the user and the advertiser if an interested user cannot easily obtain the promotional information. The user does not get the benefit of obtaining information in which the user was interested, and the advertiser misses a potential customer.

One objective of advertising is to interest the user into viewing promotional information relating to the advertisement with the goal of converting the user into a customer. Current advertising technology is able to interest the user in viewing promotional, but the technology does not capture the user who is interested but unwilling to be interrupted. The current technology does not provide the interested user with the option of receiving information at a later, more convenient time. This is a disadvantage in the current technology which results in a lower number of users who view adds and a lower conversion-to-customer rate.

Accordingly, there is a need for a system which allows a user interested in an advertisement, to have the option to view promotional information relating to the advertisement at a later time, so that the user is not interrupted from what the user is doing on the first website.

### SUMMARY

The present invention allows a computer network user who is visiting a website and who is interested in an advertisement presented on the website, to view information relating to the advertisement at a later time, without interrupting what the user is doing on the site the user is visiting. Advertisements are presented to the user with an embedded option of allowing the user to have information relating to the advertisement sent, one time, to the user's email address. The information relating to the advertisement is delivered to the user's email address in any defined format (text, HTML, Flash, executables, file attachments, etc.). The information is only sent one time to the user's email address and only in response to the user's request that the information be sent.

The present invention provides a system for transmitting promotional information that satisfies the above needs and overcomes disadvantages of current advertising systems. The system utilizes a server system that is interconnected with a user system through a computer network, where the user has an e-mail address. The server system first presents an advertisement on a website on the computer network. The advertisement has an option which allows the user to view immediate promotional information relating to the advertisement by leaving the website. The immediate promotional information provides information relating to the good or service promoted in the advertisement. The information is not necessarily the same as the advertisement. The immediate promotional information is viewed immediately by the user, which is done by directing the user to a different website. The advertisement also has a second option which allows the user to request, without leaving the website, to view subsequent promotional information that is sent to the user's email address. The subsequent promotional information provides information relating to the good or service promoted in the advertisement. The subsequent promotional information may or may not be the same as the immediate promotional information. And, the subsequent promotional information is not necessarily the same as the advertisement. The subsequent promotional information is sent to the user's email address and is subsequently viewed by the user when the user chooses to view the information from the user's email system.

When the user chooses the option to have subsequent promotional information sent to the user's email address, the server system receives a request from the user through the computer network for delivery of the promotional information to the user's email address. The server system then sends the promotional information to the user's email address. The promotional information is preferably sent only one time to the user's email address and is only in response to the user's request. Preferably, this technology does not send additional information to the user's email address at another time, unless specifically requested by the user. The advertisement may be configured such that the user clicks on a specific button in order activate the option to request promotional information be sent to the user's email address.

The server system is configured with the ability to prompt the user to enter the user's email address after receiving a request for promotional information from the user. After receiving the request from the user, if the server system is able to identify the user, the server system then retrieves the user's email address and prompts the user to confirm the user's email address. If the server system cannot identify the user, the server system requests the user to enter an email address. The server system then stores the user's email address into a database.

The server system may also be configured such that it prompts the user to select a format for the promotional information that is sent to the user's email address. The server receives the user's selection and formats the information accordingly. The promotional information is then sent to the user's email address and is followed by confirmation to the user on the website that the promotional information has been sent to the user's email address. The subsequent promotional information is not necessarily the same as the immediate promotional information viewed by the user.

The server system can have at least one server for presenting the advertisement to the user and at least one computer readable medium with an executable program stored thereon for implementing the present invention. The server system also includes a database for storing the user's email address, and advertising information. Optionally, the server system can include a content server, an ad server and an advertisement enhancement server. The advertisement enhancement server provides the option for the user to request that the promotional information be sent to the user's email address.

The present invention also provides a method for receiving promotional information through a computer network under the control of a user system. The user accesses a computer network through a client server system. The user then visits a website through the computer network where the user receives an advertisement on the website. The advertisement has an option to view immediate promotional information by leaving the website, and an alternative option to request, without leaving the website, to view subsequent promotional information sent to the user's email address. The user selects the option to view subsequent promotional information sent to the user's email address and then receives a confirmation that the promotional information was sent to the user's email address. The user engages the option to have promotional information sent to the user's email by clicking on a button on the advertisement. In one embodiment the user's email address is known by the system, and the promotional information is sent to the user's email address without requiring the user to enter an email address into the system. In a different embodiment, the user enters the user's email address and optionally selects the format for the promotional information sent to the user's email address.

### DRAWINGS

These and other features, aspects and advantages of the present invention will become better understood from the following description, appended claims, and accompanying drawings where:

FIG. 1 is a flow diagram of a process for transmitting promotional information to a user of a computer network.

FIG. 2 is a schematic of a system for transmitting promotional information to a user of a computer network.

FIG. 3 is a schematic diagram of a preferred embodiment of a system for transmitting promotional information to a user of a computer network.

FIGS. 4-7 are exemplary screen shots representing the result of several of the steps of the process illustrated in the flow diagram of FIG. 1.

FIG. 8 is a flow diagram of a process for receiving promotional information under the control of a user system.

### DETAILED DESCRIPTION OF THE INVENTION

The present invention is directed to a method for transmitting promotional information to a user of a computer network. In a preferred embodiment described herein, a user of a computer network who is viewing a website is presented with an advertisement having an option for the user to choose to have promotional information relating to the advertisement sent to the user's email address such that user does not have to immediately leave the website the user is viewing. The user's email address is a specific location where the user receives electronic mail.

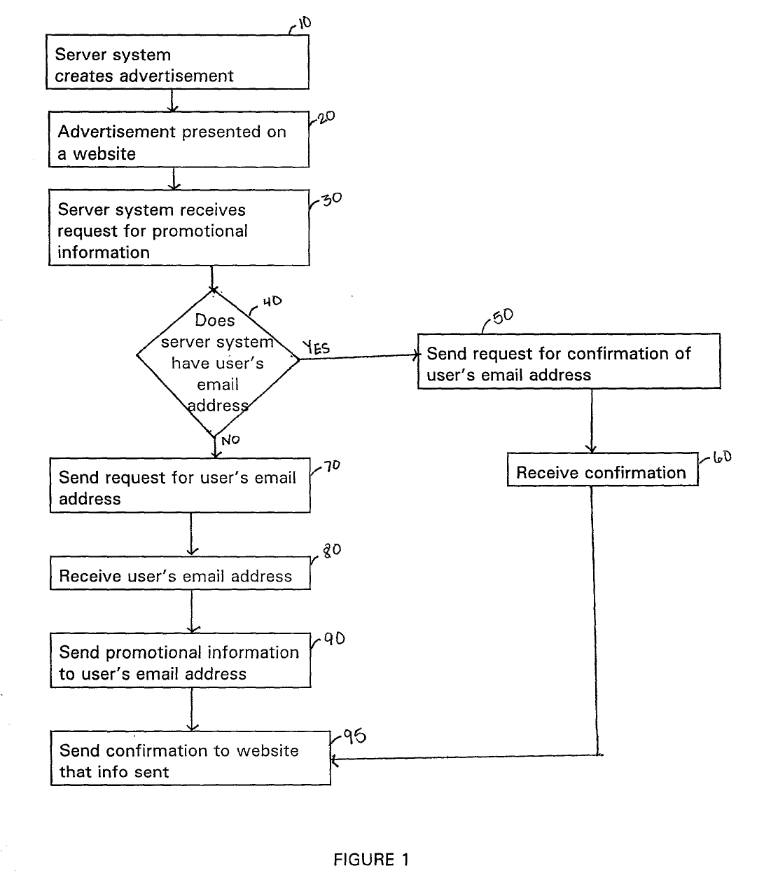

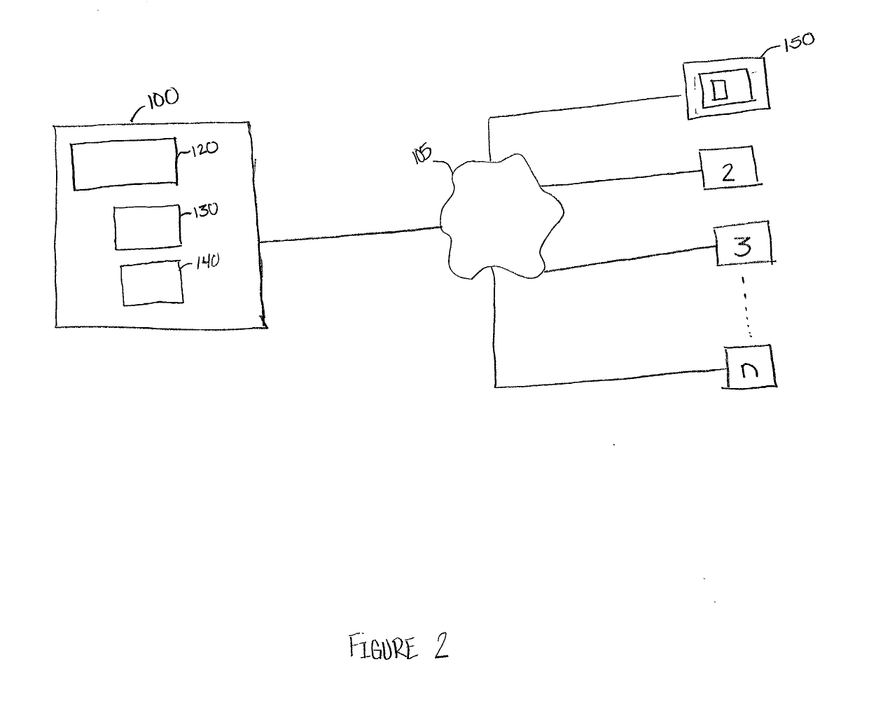

Referring to FIG. 1, the method begins with step 10, in which a server system creates an advertisement. An advertisement is a public notice designed to attract public attention or patronage to a good or service. The server system 100 is illustrated in FIG. 2. The server system 100, in FIG. 2, includes a server 120, a computer readable medium 130 and a database 140. The computer readable medium 130 stores an executable program that causes the steps of creating and presenting an advertisement. Examples of computer readable mediums include, but is not limited to tapes, floppy disks, CD-ROM, CD-R, CD-RW and DVD. Database 140, shown in FIG. 2 stores the advertisement.

Referring again to FIG. 1, after an advertisement is created in step 10, the method proceeds to step 20 where the server system presents the advertisement on a website. In FIG. 2, a server 120, of the server system 100, serves an advertisement through a computer network 105 to a user 150. The user 150 is able to view the advertisement on a website. A website is a server which contains web pages and other files. In some embodiments the website is viewable to a user through a web browser. In some embodiment, the website is construed such that it is not limited to webpages or html. The computer network 105 may include but is not limited to the Internet, devices operating independently of the internet such as appliances or web TV, or wireless communication networks.

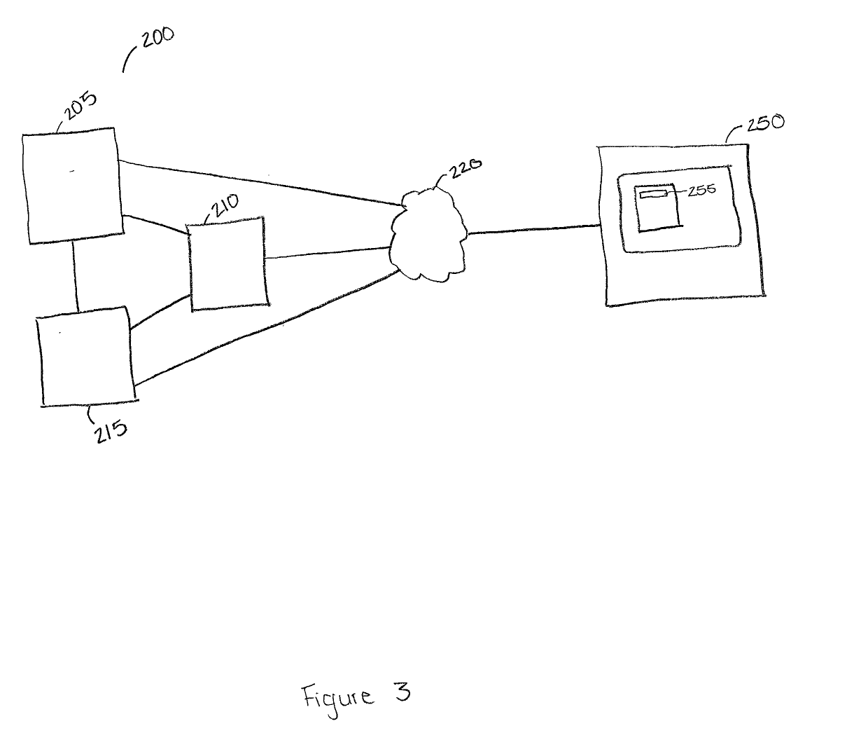

A preferred server system for presenting an advertisement is illustrated in FIG. 3. The server system 200 includes a content server 205, an ad server 210, and an advertisement enhancement server 215. Together, the content server 205, ad server 210 and advertisement enhancement server 215 serve an advertisement 255 through a computer network 220 to a website for a user 250 to view. The content server 205 supplies the contents of the advertisement. The ad server 210 delivers the HTML enhanced advertisement to a website and embeds the option to view an ad later in its HTML. The advertisement enhancement server 215 supplies the option to view the ad later, supplies the ad code and retrieves the user's email address from a browser.

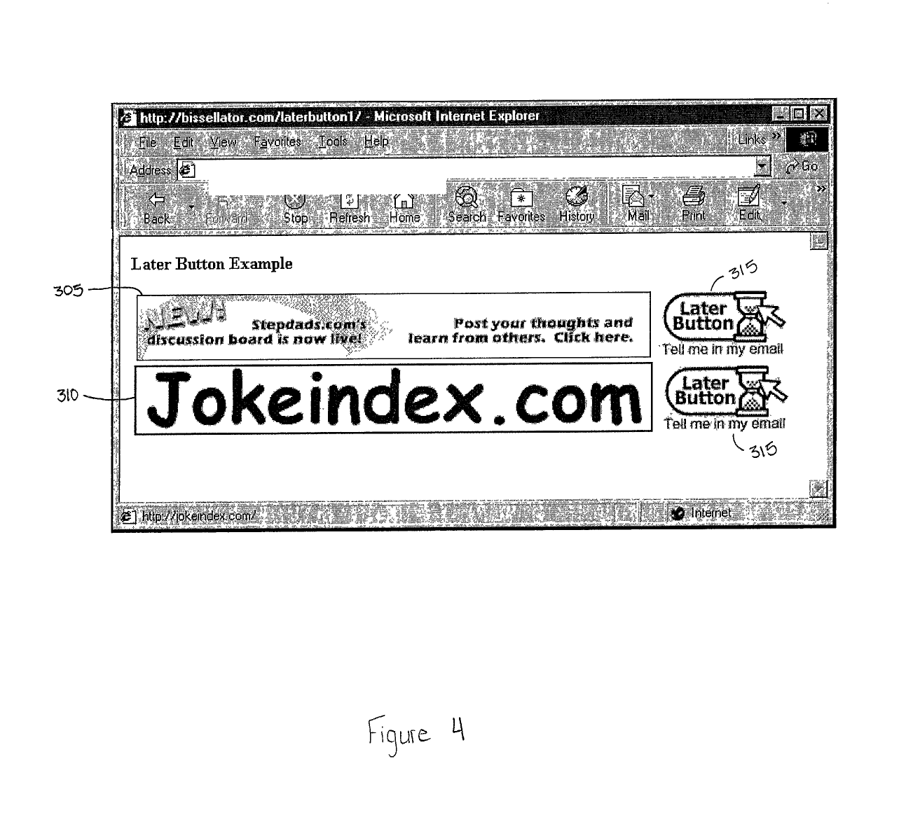

FIG. 4, illustrates advertisements 305 and 310 presented on a website by a server system 200. Advertisements 305 and 310 are embedded with an option to view the ad later. A user may choose to select an ad and by doing so will be directed to another website containing promotional information relating to the advertisement. The promotional information is information relating to the advertisement. The promotional information may contain the same information contained on the website linked to the advertisement, or the promotional information may contain different information. Advertisements 305 and 310 provide the viewer with the option of to view subsequent promotional information related to the advertisement, by sending the promotional information to the user's email address. This allows the user to remain on the website.

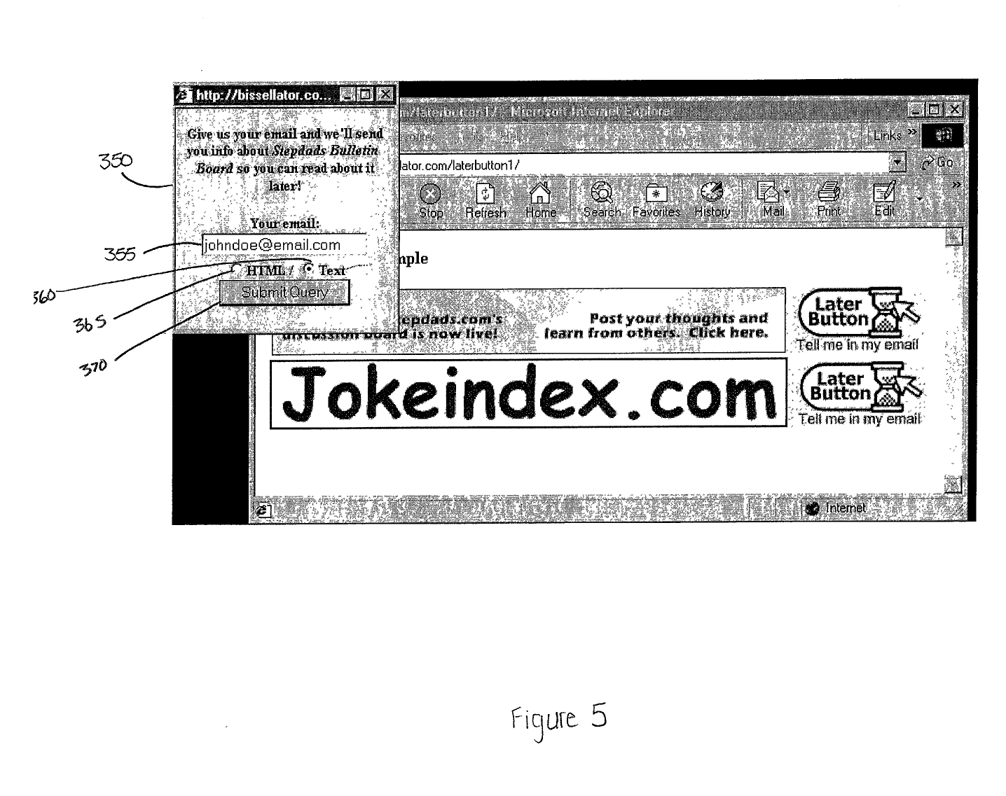

In a preferred embodiment the user may choose to have promotional information relating to the advertisement sent to the user's email address by selecting a button 315. Button 315 is a simulated button on both advertisements 305 and 310 that are engaged by clicking on it with a mouse. Once a user engages the button 315, the method proceeds to step 30 of FIG. 1, in which the server system receives a request for the promotional information to be sent to the user's email address. The server system 200 then proceeds to step 240, of FIG. 1, in which it must be determined whether the server system 200 has the user's email address. The server system may be able to access cookies stored by a browser, in which the cookies contain the user's email address. If the server system does have the user's email address, the server system proceeds to step 250, in FIG. 1, and requests the user to confirm the user's email address. FIG. 5, illustrates a popup screen 350 having a text field 355 containing the user's email address. The user confirms the address by engaging button 370. Also, in a preferred embodiment, the popup screen 350 contains radio buttons 360 and 365 which allow the user to select to format of the information being sent to the user's email address. Once the email address 355 is confirmed, the server system proceeds to step 260, in FIG. 1, and receives the confirmation. The method then proceeds to step 290 and sends promotional information to the user's email address.

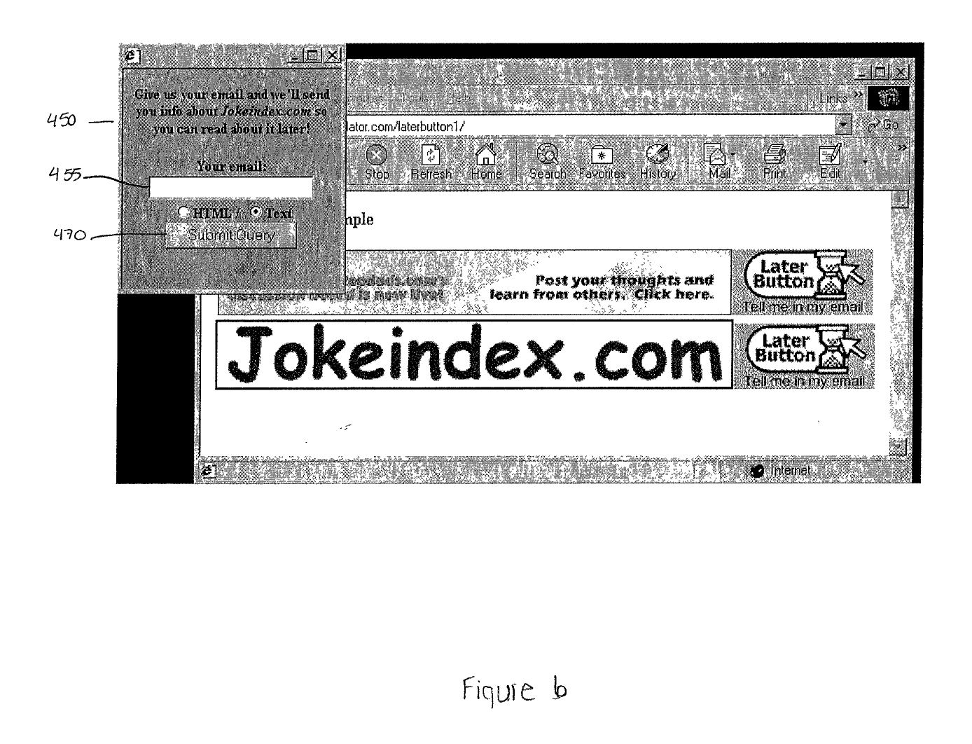

If at step 240, in FIG. 1, the server system does not have the user's email address, the system proceeds to step 270 and sends a request to the user for the user's email address. FIG. 6, illustrates a popup screen 450 having a blank text field 455 in which the user may enter the user's email address. The email address is sent to the server system by engaging button 470. Once the email address is received, the server system proceeds to step 290, in FIG. 1.

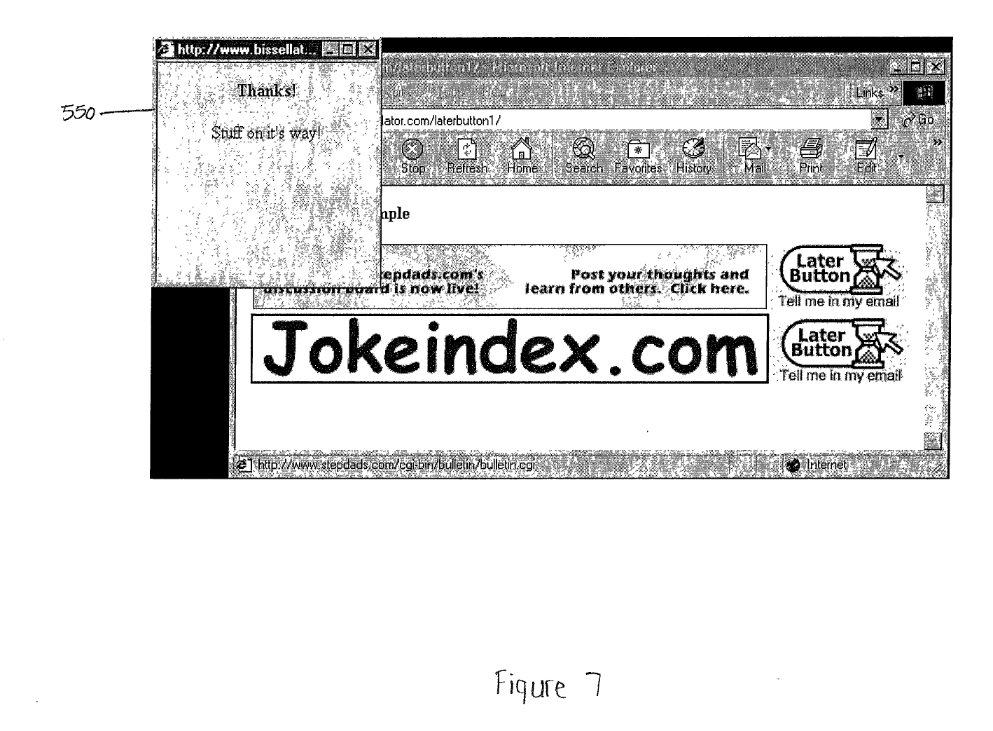

Referring to FIG. 1, in step 290, the server system sends the promotional information to the user's email address. The system then proceeds to step 295, in which a message is sent to the user confirming the promotional information has been sent to the user's email address. FIG. 7, illustrates a popup screen 550 with a message notifying the user the promotional information has been sent to the user's email address.

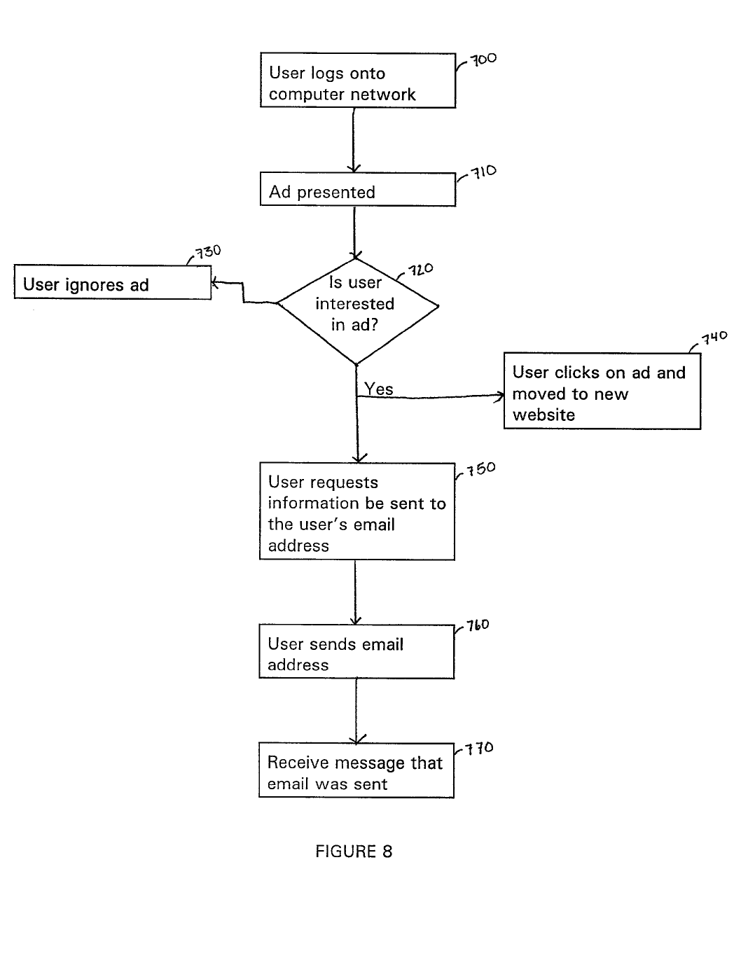

FIG. 8, illustrates a method for receiving promotional information through a computer network, under the control of a user. In step 700 a user accesses a computer network. Next, in step 710 the user is presented with and advertisement having the option for promotional information relating to the advertisement be sent to the user's email address. Next, at step 720, if the user is not interested in the advertisement, the user may do nothing and ignore the ad, as illustrated in step 730. If at step 720, the user is interested in the receiving information relating to the advertisement, the user may click on the advertisement, this is illustrated in step 740, which results in the user being directed through the network to a different website. At step 720, if the user is interested in receiving information relating to the advertisement, but does not want to leave the current website, the user may choose to have the information sent to the user's email address, this is illustrated in step 750. In step 760, the user sends the server system the user's email address, or if the server system has the user's email address, the user confirms the email address. In step 770, the user receives a message indicating the information was sent to the user's email address.

The hardware used to implement the system for transmitting promotional information is based upon need as well as cost sensitivity. A basic configuration for an initial server includes a basic web server, a single processor, 256 MB of RAM, at least one 400 MHZ Intel or AMD processor, a single hard drive and a tower case. This configuration is dependant upon the amount of traffic generated. As traffic increases the load on the server, an additional server with more functionality can be added. A server dedicated to the database can be added. An example of requirements of a databases server would be one having a dual processor, 512 MB of RAM, and at least 500 MHZ PIII for each processor.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Also, any element in a claim that does not explicitly state “means” for performing a specified function or “step” for performing a specified function, should not be interpreted as a “means” or “step” clause as specified in 35 U.S.C. § 112.

What is claimed is:

1. A method for transmitting promotional information to a user of a computer network, where the user has an e-mail address, comprising the steps of:
(a) presenting an advertisement on a website on the computer network, the advertisement having a first option for the user to view immediate promotional information by leaving the website, and a second option for the user to request, without leaving the website, to view subsequent promotional information sent to the user's email address;
(b) receiving a request from the user through the computer network for delivery of the promotional information to the user's email address; and
(c) sending the promotional information to the user's email address.

2. The method of claim 1, wherein the option to request the promotional information be sent to the user's email address is configured such that the option is engaged by selecting a specific button.

3. The method of claim 1 further comprising, after receiving a request from the user, prompting the user to enter the user's email address.

4. The method of claim 1, further comprising, after receiving a request from the user, identifying the user and retrieving the user's email address.

5. The method of claim 1, further comprising, after receiving a request from the user, prompting the user to confirm the user's email address.

6. The method of claim 1, further comprising, after receiving a request from the user, receiving the user's email address.

7. The method of claim 1, further comprising, after receiving a request from the user, storing the user's email address in a database.

8. The method of claim 1, further comprising, after receiving a request from the user, prompting the user to select a format for the promotional information sent to the user's email address.

9. The method of claim 8, further comprising, after prompting the user to select a format, receiving a format selection from the user.

10. The method of claim 1, wherein the advertisement is presented by serving code from a content server, an ad server and an advertisement enhancement server to the advertisement

11. The method of claim 10, wherein the advertisement enhancement server is the server providing the option for the user to request that the promotional information be sent to the user's email address.

12. The method of claim 1, the steps further comprising, after sending the promotional information to the user's email address, the step of sending confirmation to the user on the website that the promotional information has been sent to the user's email address.

13. The method of claim 1, wherein the subsequent promotional information sent to the user's email address is the same as the immediate promotional information viewed by a user.

14. A computer readable medium having contents for causing a computer-based information handling system to perform steps for transmitting promotional information to a user of a computer network, where the user has an e-mail address, the steps comprising:
(a) presenting an advertisement on a website on the computer network, the advertisement having a first option for the user to view immediate promotional information by leaving the website, and a second option for the user to request, without leaving the website, to view subsequent promotional information sent to the user's email address;
(b) receiving a request from the user through the computer network for delivery of the promotional information to the user's email address; and
(c) sending the information to the user's email address.

15. The computer readable medium of claim 14, wherein the option to request the promotional information be sent to the user's email address is configured such that the option is engaged by selecting a specific button.

16. The computer readable medium of claim 14, the steps further comprising, after receiving a request from the user, the step of prompting the user to enter the user's email address.

17. The computer readable medium of claim 14, the steps further comprising, after receiving a request from the user, the step of identifying the user and retrieving the user's email address.

18. The computer readable medium of claim 14, the steps further comprising, after receiving a request from the user, the step of prompting the user to confirm the user's email address.

19. The computer readable medium of claim 14, the steps further comprising, after receiving a request from the user, the step of receiving the user's email address.

20. The computer readable medium of claim 14, the steps further comprising, after receiving a request from the user, the step of storing the user's email address in a database.

21. The computer readable medium of claim 14, the steps further comprising, after receiving a request from the user, prompting the user to select a format for the promotional information sent to the user's email address.

22. The computer readable medium of claim 21, the steps further comprising, after prompting the user to select a format, receiving a format selection from the user.

23. The computer readable medium as claim 14, wherein the advertisement presented on the website contains code served from a content server, an ad server and an advertisement enhancement server.

24. The computer readable medium of claim 23, wherein the advertisement enhancement server provides the option for the user to request that the promotional information be sent to the user's email address.

25. The computer readable medium of claim 14, the steps further comprising, after sending the promotional information to the user's email address, the step of sending confirmation to the user on the website that the promotional information has been sent to the user's email address.

26. The computer readable medium of claim 14, wherein the subsequent promotional information sent to the user's email address is the same as the immediate promotional information viewed by the user.

27. A server system for transmitting promotional information to a user of a computer network comprising the computer readable medium of claim 14.

28. A server system for transmitting promotional information to a user of a computer network, where the user has an e-mail address, the server system comprising:
(a) at least one server for presenting an advertisement to a user through the computer network and sending promotional information to the user's email address, the advertisement having a first option for the user to view immediate promotional information by leaving the website, and a second option for the user to request, without leaving the website, to view subsequent promotional information sent to the user's email address;
(b) at least one computer readable medium for storing user requests to send the promotional information to the user's email address and for storing the promotional information requested by the user.

29. The server system of claim 28, wherein the option to request the promotional information be sent to the user's email address, is configured such that the option is engaged by selecting a specific button.

30. The server system of claim 28, wherein the server for presenting an advertisement to a user, prompts a user for the user's email address.

31. The server system of claim 28, wherein the server for presenting an advertisement, prompts the user to confirm the user's email address.

32. The server system of claim 28, wherein the server for presenting an advertisement, receives the user's email address.

33. The server system of claim 28, wherein the server for presenting advertisements further comprises, a database for storing the user's email address.

34. The server system of claim 28, wherein the server for presenting an advertisement sends a confirmation message to the user on the website, confirming that the promotional information has been sent to the user's email address.

35. The server system of claim 28, wherein the server for presenting an advertisement to a user, further comprises a content server, an ad server and an advertisement enhancement server.

36. The server system of claim 35, wherein the option for the user to request that the promotional information be sent to the user's email address, is provided by the advertisement enhancement server.

37. The server system of claim 35, further comprising, an ad enhancement server for sending promotional information to the user's email address.

38. The server system of 35, wherein the ad enhancement server, receives the request from the user for promotional information to be sent to the user's email address.

39. The server system of claim 35, further comprising, the ad enhancement server having a database for storing the user's email address.

40. A method for receiving promotional information through a computer network, where a client has an e-mail address, comprising the steps of:
under the control of a user system,
(a) accessing a computer network through a client server system;
(b) visiting a website through the computer network;
(c) receiving an advertisement on the website, the advertisement having a first option to view immediate promotional information by leaving the website, and a second option to request, without leaving the website, to view subsequent promotional information sent to the user's email address;
(d) selecting the option to view subsequent promotional information sent to the user's email address; and
(e) receiving a confirmation that the promotional information was sent to the user's email address.

41. The method of claim 40, further comprising, selecting the option to view subsequent promotional information sent to the user's email address by engaging a specific button.

42. The method of claim 40, further comprising, after the step of selecting the option to view, the step of receiving a prompt to enter the user's email address.

43. The method of claim 40, further comprising, after the step of selecting the option to view, the step of entering the user's email address into a screen.

44. The method of claim 40, further comprising, after the step of selecting the option to view, the step of receiving a prompt to confirm the user's email address.

45. The method of claim 40, further comprising, after the step of selecting the option to view, the step of confirming the user's email address.

46. The method of claim 40, further comprising, after the step of selecting the option to view, the step of receiving a prompt to select a format for the promotional information sent to the user's email address.

47. The method of claim 40, further comprising, after the step of selecting the option to view, the step of selecting a format for the promotional information sent to the user's email address.

48. The method of claim 40, wherein the subsequent promotional information sent to the user's email address is the same as the immediate promotional information.

49. A signal for transmitting computer information through a computer network for causing a computer-based information handling system to perform steps for transmitting promotional information to a user of a computer network, where the user has an e-mail address, the steps comprising:
(a) presenting an advertisement on a website on the computer network, the advertisement having a first option for the user to view immediate promotional information by leaving the website, and a second option for the user to request, without leaving the website, to view subsequent promotional information sent to the user's email address;
(b) receiving a request from the user through the computer network for delivery of the promotional information to the user's email address; and
(c) sending the promotional information to the user's email address.

50. The signal of claim 49, wherein the option to request the promotional information be sent to the user's email address, is configured such that the option is engaged by selecting a specific button.

51. The signal of claim 49, the steps further comprising, after receiving a request from the user, prompting the user to enter the user's email address.

52. The signal of claim 49, the steps further comprising, after receiving a request from the user, identifying the user and retrieving the user's email address.

53. The signal of claim 49, the steps further comprising, after receiving a request from the user, prompting the user to confirm the user's email address.

54. The signal of claim 49, the steps further comprising, after receiving a request from the user, receiving the user's email address.

55. The signal of claim 49, the steps further comprising, after receiving a request from the user, saving the user's email address in a database.

56. The signal of claim 49, the steps further comprising, after receiving a request from the user, prompting the user to select a format for the promotional information sent to the user's email address.

57. The signal of claim 56, the steps further comprising, after prompting the user to select a format, receiving a format selection from the user.

58. The signal of claim 49, wherein the advertisement presented on the website contains code served from a content server, an ad server and an advertisement enhancement server.

59. The signal of claim 58, wherein the advertisement enhancement server provides the option for the user to request that the promotional information be sent to the user's email address.

60. The signal of claim 49, the steps further comprising, after sending the promotional information, sending a confirmation message to the user on the website that the promotional information has been sent to the user's email address.

61. The signal of claim 49, wherein the subsequent promotional information sent to the user's email address is the same as the immediate promotional information.
